(19) United States
(12) Patent Application Publication
(10) Pub. No.: US 2025/0172404 A1
(43) Pub. Date: May 29, 2025

(54) MAP DISPLAY DEVICE

(71) Applicant: TOYOTA JIDOSHA KABUSHIKI KAISHA, Toyota-shi (JP)

(72) Inventor: Seii SAI, Yokohama-shi (JP)

(73) Assignee: TOYOTA JIDOSHA KABUSHIKI KAISHA, Toyota-shi (JP)

(21) Appl. No.: 18/813,544

(22) Filed: Aug. 23, 2024

(30) Foreign Application Priority Data
Nov. 28, 2023 (JP) 2023-200556

(51) Int. Cl. G01C 21/36

(52) U.S. Cl. CPC G01C 21/3614; G01C 21/367

(57) ABSTRACT

The user terminal comprises a display. The display is configured to display, on a map, a plurality of icons respectively representing positions of a plurality of ports operated for a rental business of moving bodies. The display displays the icons such that each of the icons are distinguished in accordance with a business that operates a port at a position indicated by an icon. When two or more ports out of the ports are established in the same area, the display displays a single representative icon representing the two or more ports on the map, in place of two or more icons each representing the two or more ports out of the icons. The representative icon represents two or more businesses operating the two or more ports in a manner distinguishable from each other.

### CROSS-REFERENCE TO RELATED APPLICATION

This application claims priority to Japanese Patent Application No. 2023-200556 filed on Nov. 28, 2023, incorporated herein by reference in its entirety.

### BACKGROUND

### 1. Technical Field

The present disclosure relates to a map display device.

### 2. Description of Related Art

Japanese Patent No. 5611081 discloses a navigation device. This device includes an area information retrieval unit and an area rendering unit. Based on area information retrieved by the area information retrieval unit, the area rendering unit renders a symbol image representing a facility concentration region in a superimposed manner at a position on a map, displayed on a display, corresponding to a representative position within the facility concentration area. At this time, the area rendering unit renders a symbol image representing the facility concentration region, in accordance with to a display form or a color corresponding to the total number of facilities present in the facility concentration region (see and FIG. 4).

### SUMMARY

In the rental business of moving bodies (e.g., automobiles, bicycles, or electric kickboards), positions of ports are important information for a user. The reason is that where the moving body can be borrowed or returned has a direct bearing on convenience of the user. There is demand for users to easily comprehend a position of a port that they are interested in. In particular, users may want to easily comprehend the positions of ports of a business they are interested in.

The present disclosure has been made in order to solve the above-described problem, and an object thereof is to provide a map display device for easily comprehending a position of a port of a business that the user is interested in.

A map display device of the present disclosure includes a display. The display is configured to display, on a map, a plurality of icons respectively representing positions of a plurality of ports operated for a rental business of moving bodies.

Each of the ports is operated by any one of a plurality of businesses carrying out the rental business.
The display displays the icons such that each of the icons are distinguished in accordance with a business that operates a port at a position indicated by an icon.
When two or more ports out of the ports are established in the same area, the display displays a single representative icon representing the two or more ports on the map, in place of two or more icons each representing the two or more ports out of the icons.
The representative icon represents two or more businesses operating the two or more ports in a manner distinguishable from each other.

According to the above configuration, the user does not need to visually recognize the two or more icons, one at a time, in order to distinguish and recognize the respective businesses that operate the ports in the area, and only needs to visually recognize the representative icon. As a result, the user can easily comprehend the position of the port of the business that he/she is interested in (whether a port of that business is established in this area) based on the representative icon.

In an aspect, two or more businesses are respectively associated with two or more colors. The representative icon includes two or more regions respectively represented by the two or more colors.

The colors can effectively visually appeal to the user. According to the above configuration, each region of the representative icon represents a business associated with a color representing the region. This allows the user to distinguish and recognize each of the two or more businesses in a particularly easy (intuitive) manner.

In an aspect, with respect to each of the two or more regions, an area of a region is larger in proportion with a total number of ports operated in the area by the business associated with a color representing the region, or,

the two or more regions are laid out in descending order of the total number.

According to the above configuration, each of the two or more businesses is distinguished in the representative icon in accordance with the total number of ports operated by that business in the area. Thus, the user can be made to easily recognize how many ports of each business are established in the area, and in particular, the user can be made to easily recognize the business having the greatest total number.

In an aspect, with respect to each of the two or more regions, the area of the region is larger in proportion with the total number.

The representative icon includes two or more circles laid out concentrically.
A region represented by a color associated with a top business operating the greatest total number of the ports operated in the area, among the two or more businesses, is a center region of the representative icon encircled by an innermost circle among the two or more circles.

The center region is laid out at the center of the representative icon, and accordingly the center region can conceivably be more intuitively recognized by the user than other regions among the two or more regions. According to the above configuration, the top business having the greatest total number of the ports is represented by the center region. As a result, the top business can be recognized particularly intuitively by the user.

In one aspect, the color representing the center region is a corporate color of the top business.

The center region includes a logo of the top business.

Each of the corporate colors and logos of the top business reminds users of the top business more effectively. According to the above configuration, when the user visually recognizes the representative icon, both the corporate color and the logo of the top business are visually recognized. This allows the user to recognize the top business in a surer manner.

According to the present disclosure, the position of the port of the business that the user is interested in can be easily comprehended.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an overall configuration of a map display system according to an embodiment;

FIG. 2 is a diagram illustrating an exemplary window displayed on an HMI device of a user terminal;

FIG. 3 is a diagram illustrating an exemplary picture displayed on a human machine interface (HMI) device of a user terminal in the embodiment;

FIG. 4 is a flowchart illustrating a process executed in the embodiment;

FIG. 5 is a diagram for describing a representative icon in Modification 1 of the embodiment; and

FIG. 6 is a diagram for describing various representative icons in Modification 2 of the embodiment.

### DETAILED DESCRIPTION OF EMBODIMENTS

Hereinafter, embodiments of the present disclosure will be described in detail with reference to the drawings. The same or corresponding parts in the drawings are denoted by the same reference numerals, and the description thereof will not be repeated. Each of the embodiments and the modifications thereof may be combined with each other as appropriate.

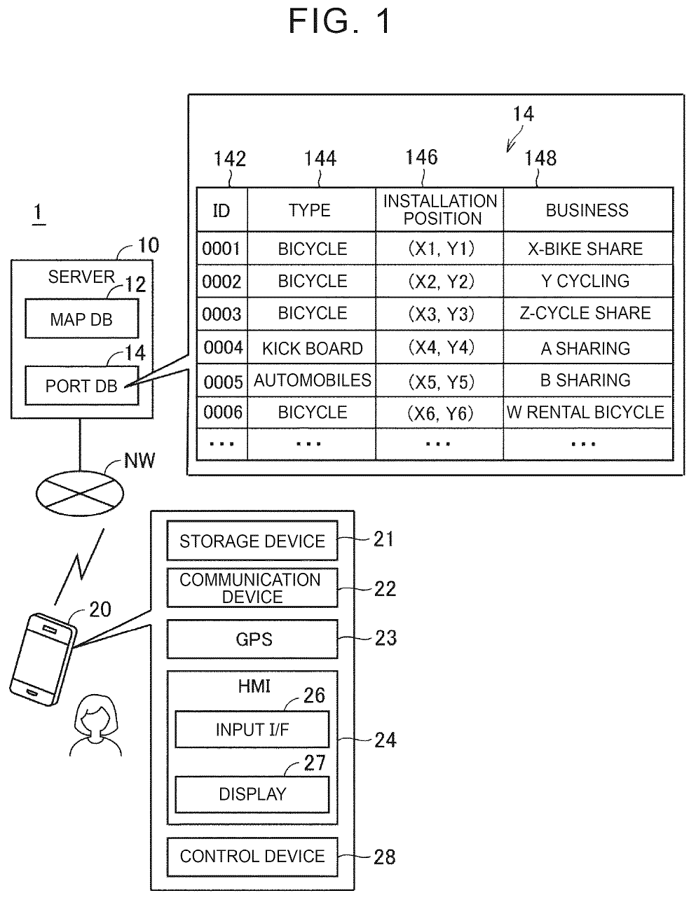

FIG. 1 is a diagram illustrating an overall configuration of a map display system according to the present embodiment. Referring to FIG. 1, the map display system 1 includes a server 10 and a user terminal 20.

The server 10 communicates with other devices (e.g., the user terminal 20) over a networked NW. The server 10 stores the map database (DB) 12 and the port DB 14. The map DB 12 includes various types of map data. The port DB 14 includes various types of information about ports operated for a rental (sharing) business for moving bodies. The port is a space used for renting or returning a moving body. The moving body is, for example, a bicycle, an electric kick board, a motorcycle, or an automobile.

The port DB 14 includes ID information 142, type information 144, installation position information 146, and business information 148. ID information 142 represents identification information of the corresponding port. The type information 144 represents the type of moving body rented or returned at the corresponding port. The installation position information 146 represents the installation position of the corresponding port. The business information 148 represents the name of the business that operates the corresponding port. In this example, a plurality of businesses (including a first business, a second business, and a third business, which will be described later) implement a rental business of a moving body.

The user terminal 20 is a portable terminal such as a smartphone, and functions as a portable map display device operated by a user. The user terminal 20 includes a storage device 21, a communication device 22, a global positioning system (GPS) 23, an HMI device 24, and a control device 28.

The storage device 21 stores a map application. The communication device 22 communicates with the server 10 through a networked NW. GPS 23 acquires position data indicating the present position of the user.

HMI device 24 is, for example, a touch screen, and includes an input interface (I/F) 26 and a display 27. The input interface 26 receives an operation (user operation) by a user. The user operation includes a search operation for searching a port on a map displayed using the map app. The user operation further includes screen operations such as swipe, pinch-in (enlargement), and pinch-out (reduction). The display 27 is configured to display a map and icons of various ports on the map in accordance with signals transmitted from the server 10 (described in detail below). The display 27 is also configured to display the present position of the user on the map in accordance with the position of GPS 24. The area represented by the map changes automatically when the user moves and changes its current position, or changes in response to a screen operation such as swiping.

The control device 28 includes a central processing unit (CPU) and memories (none of which are shown). CPU executes various arithmetic processes. The memories include a read only memory (ROM) and a random access memory (RAM). ROM stores a program executed by CPU. The control device 28 detects a user manipulation performed on HMI device 24. The control device 28 executes various determination processes and controls the communication device 22 and the display 27 in response to a user operation.

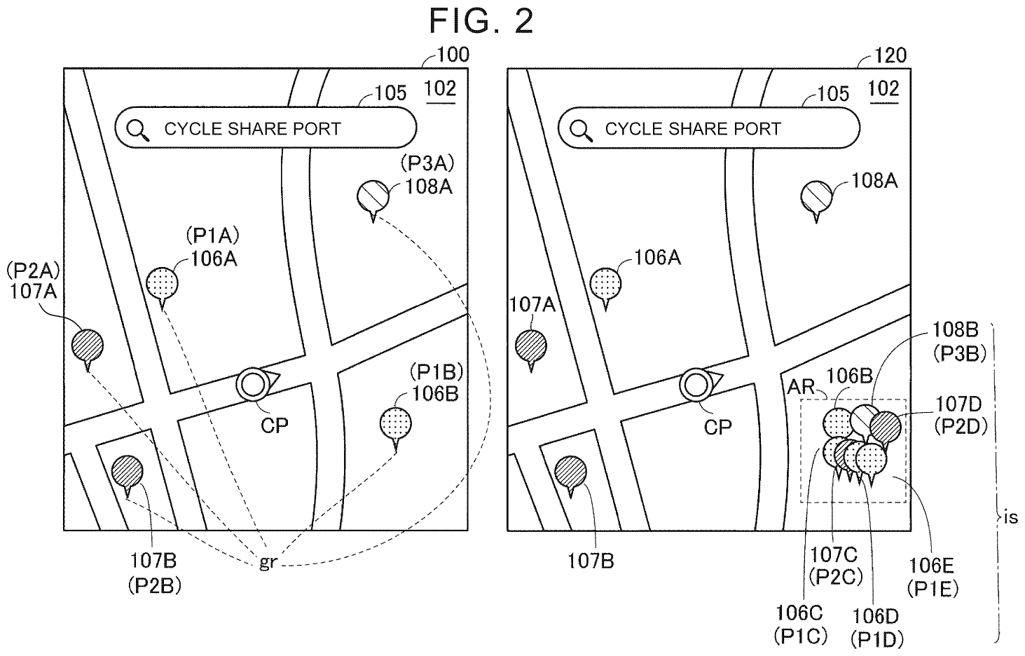

FIG. 2 is a diagram illustrating an exemplary window displayed on HMI device 24 of the user terminal 20. In the present embodiment, it is assumed that the moving body used in the rental business is a bicycle.

Referring to the left-hand diagram of FIG. 2, the screen 100 includes a map 102, a current position icon CP, a search window 105, and an icon group gr.

The map 102 is displayed while the map app is in use, and represents a target region (in this example, a region around the current position of the user). The user terminal 20 receives the map information transmitted from the server 10 based on the map DB 12, and displays the map 102 according to the map information. The map information includes target region information representing a target region. The current position icon CP is displayed according to the position of GPS 23 and represents the current position of the user. In addition to the current position icon CP, the search window 105, and the icon group gr, other objects (not shown) representing facilities such as stores are displayed on the map 102.

A search word is input to the search window 105 by the user. In this example, it is assumed that a search operation for searching for a port for a rental cycle (cycle share) on the map 102 is performed by the user. In response to the search operation, the control device 28 of the user terminal 20 controls the communication device 22 to transmit a request signal for requesting port information from the server 10. The port information includes information representing the number of ports in the area surrounding the user's current position, the installation position, and the business. The request signal includes a search word input to the search window 105 and position information indicating a current position of the user.

In response to the request signal, the server 10 determines the ports in the region and the business thereof. This determination process is executed in accordance with the search word and the user's position information included in the request signal, the type information 144 of the port DB 14, the installation position information 146, and the business information 148. The server 10 generates port information according to the determination result and transmits the port information to the user terminal 20. When the communication device 22 receives the port-information, the control device 28 controls the display 27 to display the icon-group gr on the map 102.

The icon group gr includes N (N≥2) icons (in this case, icons 106A, 106B, 107A, 107B, 108A). These icons represent the positions of the ports P1A, P1B, P2A, P2B, P3A, respectively.

These ports are located in the area represented by the map 102 and are operated by any one of the first business, the second business, and the third business. Specifically, the ports P1A, P1B are operated by the first business, the ports P2A, P2B are operated by the second business, and the port P3A is operated by the third business.

The display 27 displays the icon group gr such that the icons of the icon group gr are distinguished according to the business who operates the port of the position represented by the icon.

For example, the icon 106A, 106B indicating the position of the port of the first business is displayed by being graphically distinguished from the icon 107A, 107B, 108A indicating the position of the port of another business (in this example, the second business and the third business). In this instance, it is assumed that the first business is associated with a first color (e.g., red), and the icon 106A, 106B is represented by this color.

Similarly, the icon 107A, 107B representing the position of the port of the second business is graphically distinguished from the icon 108A representing the position of the port of the third business. In this instance, it is assumed that the second business is associated with a second color (e.g., blue), and the icon 107A, 107B is represented by this color. It is assumed that the third business is associated with a third color (e.g., green), and the icon 108A is represented by this color.

By displaying the icon group gr in this manner, the user can intuitively recognize the position of the port of which business is operating the respective icons. As a result, the user can easily ascertain the position of the port of the business of interest (e.g., the business that the user favors, in one example, the business that has registered as a member).

When the user touches any icon of the icon group gr, the display 27 may display detailed information of the port at the position represented by the touched icon, or may display a user interface for reserving the port. Detailed information of the port includes, for example, an address of the port, an available time of the port, a business of the port, the number of bicycles that can be rented and the number of bicycles that can be returned at the port.

The right view of FIG. 2 is shown as a comparative example when a single icon to be described later is not displayed. Referring to the right-hand diagram of FIG. 2, the screen 120 differs from the screen 100 in that the icon group gr further includes an icon 106C to 106E, 107C, 107D, 108B. These icons represent the positions of the ports P1C to P1E, P2C, P2D, P3B, respectively.

Each of the ports P1C to P1E, P2C, P2D, P3B is operated by one of a first business, a second business, and a third business. Specifically, the ports P1C to P1E are operated by the first business, the ports P2C, P2D are operated by the second business, and the port P3B is operated by the third business.

The icon 106B to 106E, 107C, 107D, 108B is also represented as an icon set is. The ports P1B to P1E, P2C, P2D, P3B are installed in concentration in the same area (area AR). The icon 106B to 106E, 107C, 107D, 108B corresponds to an exemplary “two or more icons” of the present disclosure. The ports P1B to P1E, P2C, P2D, P3B correspond to an exemplary “two or more ports” of the present disclosure.

The area AR is an area having a predetermined shape and width. An area in which a large number of ports (specifically, a predetermined number or more) are densely packed in concentration, such as an area AR, is also referred to as a “port concentration area”.

The user often searches for a port on the go. Since the user terminal 20 is a portable terminal such as a smartphone, the display 27 is generally small. On the other hand, in recent years, there has been an increase in the number of businesses entering the moving body rental business. As a result, a situation tends to occur in which a user terminal 20 is used to search for a port operated by an interested business from among various ports operated by various businesses. The user terminal 20 has a display 27 of a limited size. A business is, for example, a business that a user favors, and in one example, a business that is registered as a member. In such a case, a need to easily grasp position information of a port of a business who is interested in the user may be particularly remarkable.

However, in the comparative example shown in FIG. 2, since a large number of ports are installed in concentration in the area AR, a large number of icons belonging to the icon set is also arranged in concentration. As a consequence, the user may not be able to easily grasp the position of the port of the business of interest (whether or not the port of the business is installed in the area AR) based on these icons.

The user terminal 20 according to the present embodiment has a configuration for coping with the above-described problems. This point will be described below.

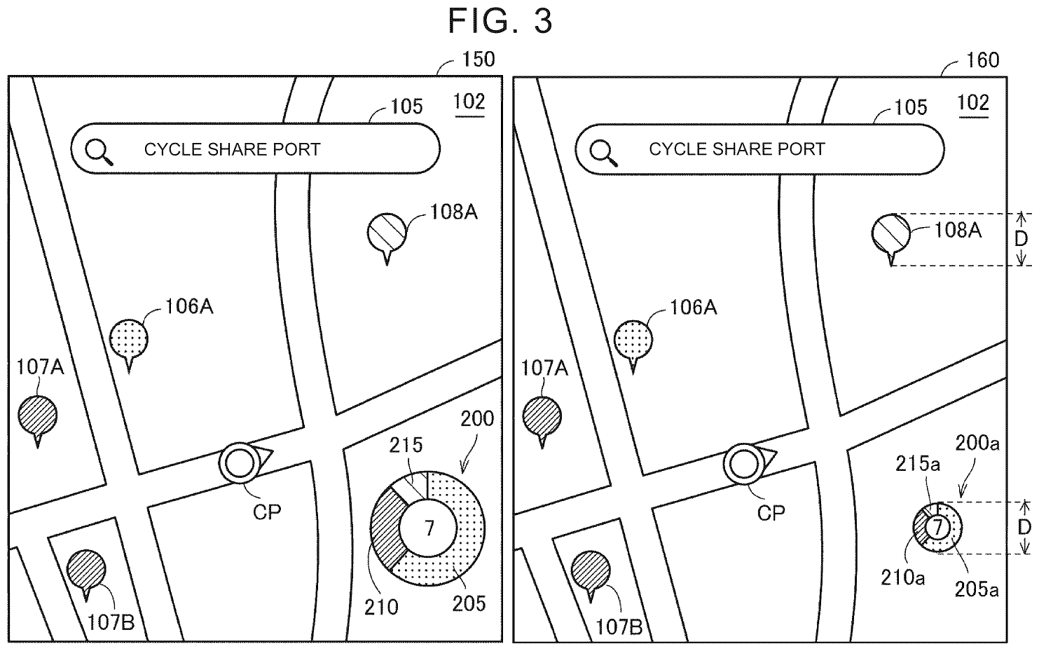

FIG. 3 is a diagram illustrating an exemplary window displayed on HMI device 24 of the user terminal 20 in the present embodiment. Referring to the left view of FIG. 3, this example differs from the comparative example of the right view of FIG. 2 in that the display 27 displays the screen 150 instead of the screen 120. The screen 150 includes a representative icon 200 instead of the icon set is.

The representative icon 200 is displayed on the map 102 as a single icon. The representative icon 200 represents ports P1B to P1E, P2C, P2D, P3B in the area AR instead of the icons 106B to 106E, 107C, 107D, 108B. The representative icon 200 represents the total number n of ports in the area AR (n=7 in this case) in its center region.

The representative icon 200 represents two or more businesses that operate these ports (in this example, the first business, the second business, and the third business) in a manner distinguishable from each other (in other words, represents a breakdown of the businesses of the ports in the area AR). Specifically, the representative icon 200 includes regions 205, 210, 215. The region 205 is represented by a first color associated with the first business. The region 210 is represented by a second color associated with the second business. The region 215 is represented by a third color associated with the third business. The regions 205, 210, 215 corresponds to an example of “two or more regions” of the present disclosure.

According to the representative icon 200, the user does not need to visually recognize the icon 106B to 106E, 107C, 107D, 108B shown in the right-hand side of FIG. 2 one by one, and only needs to visually recognize the representative icon 200 in order to distinguish and recognize the respective businesses who operate the ports in the area AR. Consequently, the user can easily grasp the position of the port of the business of interest (whether or not the port of the business is installed in the area AR) on the basis of the representative icon 200.

In an embodiment, the representative icon 200 includes regions 205, 210, 215 assigned to each of the first through third businesses. Each region has a color associated with the corresponding business. The color can effectively appeal to the user's vision, so that the user can distinguish and recognize the business operating the port in the area AR based on the representative icon 200 particularly easily (intuitively).

For each of the regions 205, 210, 215, the area of the region is larger as the total number of ports operated in the area AR by the business associated with the colors representing the region increases. For example, in an area AR, a first business operates four ports P1B to P1E, a second business operates two ports P2C, P2D, and a third business operates one port P3B. Therefore, in the regions 205, 210, 215, the region 205 has the largest area, the region 210 has the second largest area, and the region 215 has the smallest area.

With such a configuration, each of the businesses of the ports in the area AR is distinguished on the representative icon 200 according to the total number of ports operated by the business in the area AR. Specifically, each business is displayed such that the larger the total number, the larger the region allocated to the business. Accordingly, the user can easily recognize how many of the businesses' ports are installed in the area AR, and in particular, the user can easily recognize the business having the largest total number (hereinafter, also referred to as the “top business”). In this example, the top business is the first business.

The size (area) of the representative icon 200 may be determined according to the total number n of ports in the area AR. In this instance, the representative icon 200 is sized n (=7) times the size of other icons (hereinafter also referred to as “normal icons”), such as icon 106A. With such a configuration, since the representative icon 200 is larger as the number of ports in the area AR is larger, it is possible to allow the user to more easily recognize the information related to these ports. The total number n of ports in the area AR corresponds to the total number of ports operated by the respective businesses in the area AR for each business.

Referring to the right view of FIG. 3, this example differs from the left view of FIG. 3 in that the display 27 displays the screen 160 instead of the screen 150. The screen 160 includes a representative icon 200a in place of the representative icon 200.

The representative icon 200a differs from the representative icon 200 in that it has the same size as the normal icon. Otherwise, the representative icon 200a is the same as the representative icon 200 (for example, the region 205a to 205c of the representative icon 200a is assigned to the first to third businesses, respectively).

With such a configuration, it is possible to avoid a situation in which another object (representing a facility such as a store) in the vicinity of the representative icon 200a is covered and hidden by the representative icon 200a on the map 102 of the display 27 having a limited size. In addition, the user can easily recognize the businesses of the ports in the area AR.

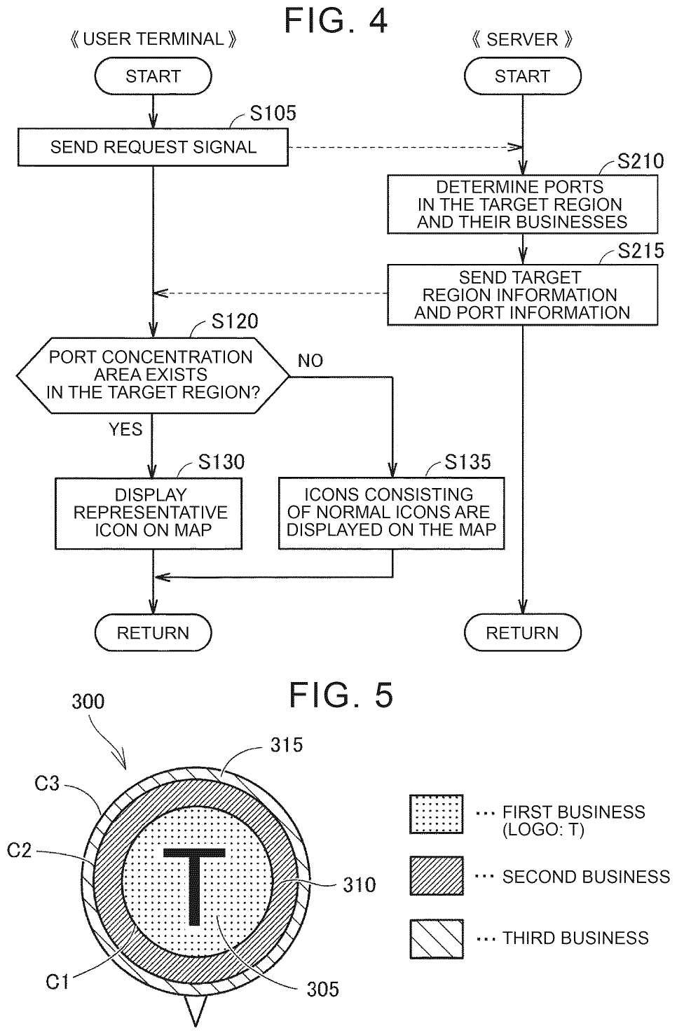

FIG. 4 is a flowchart illustrating a process executed in the present embodiment. This flow chart is started when the above-described search is performed on HMI device 24. Further, this flowchart is started when a screen operation (swipe, pinch-in, pinch-out, or the like) is performed by the user or when a predetermined cycle has elapsed when the current position of the user has changed. Hereinafter, the step is abbreviated as “S”. The control device 28 executes S105, S120, S130, S135 described below by executing a program stored in the memory.

Referring to FIG. 4, the control device 28 of the user terminal 20 controls the communication device 22 to transmit a request signal for requesting port-information to the server 10 (S105).

In response to the request-signal, the server 10 determines the target area and determines a port in the region and its business (S210). The server 10 generates and transmits the target region information and the port information to the user terminal 20 according to S210 (S215).

In response to receiving the target region information and the port information, the control device 28 of the user terminal 20 determines whether or not a port concentration area exists in the target area (S120). For example, the control device 28 virtually divides the target area into a plurality of areas each having a predetermined shape and a predetermined width on a map. Then, the control device 28 determines whether or not a predetermined number or more of ports are in concentration in at least one of these areas according to the target region information and the port information.

If there is a port concentration area (YES in S120), the control device 28 S130 the display 27 to display a representative icon representing a number of ports in the area along with other normal icons on the map 102. In the example shown on the left side of FIG. 3, the control device 28 controls the display 27 to display the representative icon 200 together with the icon 106A, 107A, 107B, 108A on the map 102.

If the port concentration area does not exist (NO in S120), the control device 28 controls the display 27 to display a group of icons (e.g., the icon group gr in the left-hand figure of FIG. 2) consisting of normal icons on the map 102 (S135). After S130, S135, the process transitions to returns.

As described above, according to the embodiment, the representative icon is displayed on the map 102 when the port concentration area exists. Thus, the user can easily grasp the position of the port of the business who is interested in himself/herself on the basis of the representative icon.

### Alternative Embodiment 1

The representative icon may be different from the representative icon 200 or 200a (FIG. 3) as long as the business of the port in the port concentration area is differently represented.

FIG. 5 is a diagram for explaining a representative icon in the first modification. Referring to FIG. 5, the representative icon 300 includes a circle C1, C2, C3, and is used instead of the representative icon 200 or 200a. These circles are arranged concentrically. The circle C1 is disposed on the innermost side of the circle C1 to C3. The circle C2 is arranged between the circle C1 and the circle C3. The circle C3 corresponds to the outer circumference (outline) of the representative icon 300.

The representative icon 300 includes regions 305, 310, 315. The region 305 is displayed as a center region of the representative icon 300 surrounded by a circle C1 and is represented by a first color associated with the first business, similar to the region 205 (FIG. 3). Region 310 is located between C1, C2 and is represented by a second color associated with the second business, similar to region 210. Region 315 is located between C2, C3 and is represented by a third color associated with the third business, similar to region 215.

Also in this case, the respective businesses are distinguished on the representative icon 300 according to the total number of ports operated by the business in the area AR. Specifically, each business is displayed such that the larger the total number, the larger the region allocated to the business. In this example, since the total number is larger in the order of the first business, the second business, and the third business, the region 305 is the largest, the region 310 is the second largest, and the region 315 is the third largest.

Since the region 305 is arranged at the center of the representative icon 300, it is considered that the regions 310, 315 is more intuitively recognized by the user. As a result, the first business, which is the top business in the area AR, is indicated by the center region (region 305) of the representative icon 300. As a result, the top business can be recognized particularly intuitively by the user.

In this example, the color representing the region 305 is the corporate color of the top business (first business), and the region 305 includes the logo (e.g., “T”) of the business.

Each of the business's corporate colors and logos more effectively reminds the user of the business. With the above configuration, when the user visually recognizes the representative icon 300, the user visually recognizes both the corporate color and the logo of the first business, which is the top business. Thus, it is possible to allow the user to reliably recognize that the top business is the first business. Consequently, when the business of interest is the first business, the user can reliably recognize that the port of the business is installed in the area AR.

In this example, only region 305 of regions 305, 310, 315 includes the business's logo. As a result, the regions 310, 315 also reduce the information on the business than the example including the logos of the second business and the third business. As a result, it is possible to allow the user to more easily recognize that the first business is the top business.

### Alternative Embodiment 2

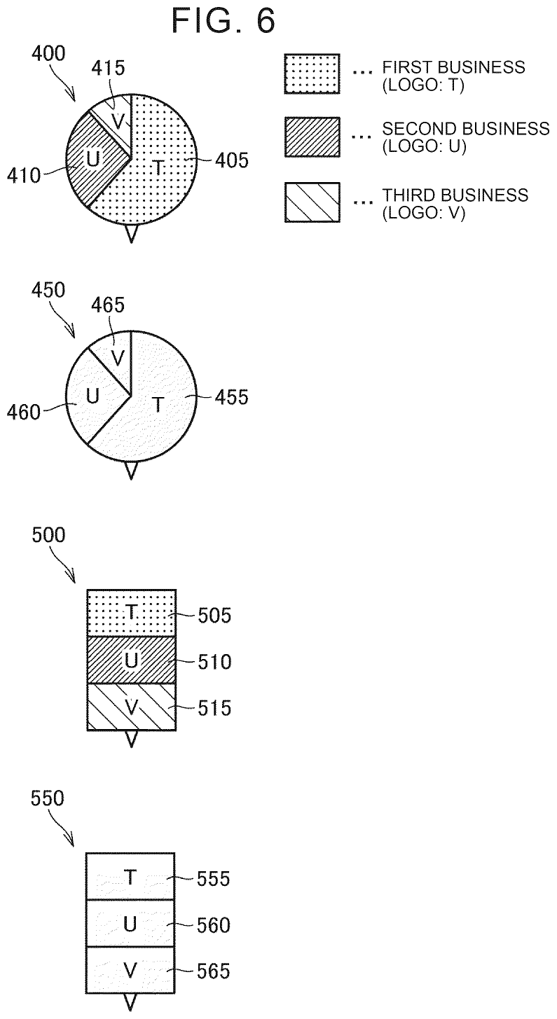

In this modification, still another example of the representative icon will be described. FIG. 6 is a diagram for explaining various representative icons in Modification 2.

Referring to the first row of FIG. 6, the representative icon 400 differs from the representative icon 200, 200a, 300 in that it is represented by a pie chart. However, it is the same as these representative icons in that they represent the businesses of the ports in the area AR in a distinguishable manner. The representative icon 400 includes regions 405, 410, 415.

The region 405 is represented by a first color associated with the first business and includes a logo (“T”) of the first business. The region 410 is represented by a second color associated with the second business and includes a logo (“U”) of the second business. The region 415 is represented by a third color associated with the third business and includes a logo (“V”) of the third business.

In the representative icon 400, the size of each region is related to the ratio of the total number of ports operated by the business representing the region in the port concentration area to the total number of ports n in the area. For example, the larger the total number (ratio), the larger the area of the region allocated to the business. In this example, the above-described areas are larger in the order of the regions 405, 410, 415.

Referring to the second row of FIG. 6, the representative icon 450 differs from the representative icon 400 in that it is not represented by color (monochrome). However, it is the same as the representative icon 400 in that the business of the port in the area AR is represented in a manner distinguishable from each other. The representative icon 450 includes regions 455, 460, 465. The regions 455, 460, 465 include logos of the first business, the second business, and the third business, respectively. Also in the representative icon 450, the area of the region allocated to the business is larger as the total number (ratio) is larger. Note that it is not essential that the region of the representative icon is larger as the total number is larger, and it may be arranged in descending order of the total number as described below.

Referring to the third row of FIG. 6, the representative icon 500 differs from the representative icon 200, 200a, 300, 400, 450 in that it is not circular (in this instance, it is polygonal). However, it is the same as these representative icons in that they represent the businesses of the ports in the area AR in a distinguishable manner.

The representative icon 500 includes regions 505, 510, 515. The region 505 is represented by a first color and includes a logo of the first business. The region 410 is represented by a second color and includes a logo of a second business. The region 415 is represented by a third color and includes a logo of a third business. The areas of the three regions are the same in this example.

Each of the regions 505, 510, 515 is arranged so as to be arranged in descending order of the total number of ports operated in the port concentration area by the business representing the region. In this example, since the total number is larger in the order of the first business, the second business, and the third business, the regions 505, 510, 515 are arranged in this order from the top. Note that these regions may be displayed side by side. For example, the regions 505, 510, 515 may be arranged in this order from the left (or right).

Referring to the fourth row of FIG. 6, the representative icon 550 differs from the representative icon 500 in that it is not represented by color (monochrome). However, it is the same as the representative icon 500 in that the business of the port in the area AR is represented in a manner distinguishable from each other. The representative icon 550 includes regions 555, 560, 565. The regions 555, 560, 565 include logos of the first business, the second business, and the third business, respectively. Each of these regions is arranged so as to be arranged in descending order of the total number as in the example of the third-stage diagram of FIG. 6.

Each of the representative icons 400, 450, 500, 550 may be used in place of the representative icon 200, 200a or 300. According to the representative icon 400, 450, 500, 550, similarly to the representative icon 200, 200a, 300, the user can easily recognize the details of the business of the port in the area AR. Therefore, the user can easily grasp whether or not the number of ports of an interested business is installed in the area AR.

### Other Embodiments

In the above-described embodiment and the modifications 1 and 2, the moving body used in the rental business of the moving body is a bicycle, but the moving body may be an electric kick board, a motorcycle, or a vehicle. In this case, the port operated by the business corresponds to a space used for renting/returning the moving body. For example, when the moving body is a vehicle, a parking lot for rental/return corresponds to a “port”.

The embodiment disclosed herein should be considered to be exemplary and not restrictive in all respects. It is intended that the scope of the disclosure be defined by the appended claims rather than the foregoing description, and that all changes within the meaning and range of equivalency of the claims be embraced therein.

What is claimed is:

1. A map display device comprising a display configured to display, on a map, a plurality of icons respectively representing positions of a plurality of ports operated for a rental business of moving bodies, wherein:
each of the ports is operated by any one of a plurality of businesses carrying out the rental business;
the display displays the icons such that each of the icons are distinguished in accordance with a business that operates a port at a position indicated by an icon;
when two or more ports out of the ports are established in the same area, the display displays a single representative icon representing the two or more ports on the map, in place of two or more icons each representing the two or more ports out of the icons; and
the representative icon represents two or more businesses operating the two or more ports in a manner distinguishable from each other.

2. The map display device according to claim 1, wherein:
the two or more businesses are respectively associated with two or more colors; and
the representative icon includes two or more regions respectively represented by the two or more colors.

3. The map display device according to claim 2, wherein:
with respect to each of the two or more regions, an area of a region is larger in proportion with a total number of ports operated in the area by the business associated with a color representing the region; or
the two or more regions are laid out in descending order of the total number.

4. The map display device according to claim 3, wherein:
with respect to each of the two or more regions, the area of the region is larger in proportion with the total number;
the representative icon includes two or more circles laid out concentrically; and
a region represented by a color associated with a top business operating the greatest total number of the ports operated in the area, among the two or more businesses, is a center region of the representative icon encircled by an innermost circle among the two or more circles.

5. The map display device according to claim 4, wherein:
the color representing the center region is a corporate color of the top business; and
the center region includes a logo of the top business.
